(19) United States
(12) Patent Application Publication
(10) Pub. No.: US 2020/0393116 A1
(43) Pub. Date: Dec. 17, 2020

(54) WEARABLE LED PATH ILLUMINATORS

(71) Applicant: Charles Wesley Strain, Keota, OK (US)

(72) Inventor: Charles Wesley Strain, Keota, OK (US)

(21) Appl. No.: 16/900,216

(22) Filed: Jun. 12, 2020

Related U.S. Application Data
(60) Provisional application No. 62/860,784, filed on Jun. 13, 2019.

(51) Int. Cl. F21V 21/08; F21L 4/08; F21V 23/04; F21V 23/06; F21V 7/00

(52) U.S. Cl. CPC F21V 21/0816; F21L 4/08; F21Y 2115/10; F21V 23/06; F21V 7/0008; F21V 23/0414

(57) ABSTRACT

A specially designed lightweight wearable LED path illuminator that wraps around a wearer's legs so they can see where they're going when they're out at night. The path illuminators have a concave reflecting surface to focus the light emitted by a LED light strip down around the user's feet. A leg ring fastens around the user's leg via a buckle and adjustable straps. The leg ring is preferably lined with a conformable material such as rubber or foam for the user's comfort. The LED light strip is turned on and off by a control switch.

### CROSS-REFERENCE TO RELATED APPLICATION

The present application is related to and claims priority from prior provisional application Ser. No. 62/860,784, filed Jun. 13, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The present invention relates generally to the field of illumination devices and more specifically relates to wearable LED path illuminators that wrap around a user's legs so they can see where they're walking when they're out at night.

### 2. Description of the Related Art

Walking in the dark can be fraught, and so many people use a flash light to illuminate the path in front of them. A flashlight (more often called a torch outside North America) is a portable hand-held electric light. The source of the light is usually an incandescent light bulb (lamp) or light-emitting diode (LED). A typical flashlight consists of the light source mounted in a reflector, a transparent cover (sometimes combined with a lens) to protect the light source and reflector, a battery, and a switch. These are supported and protected by a case.

Unfortunately, many flashlights are too week to illuminate the entire path area, and require the user to dedicate a hand to hold the flashlight, making it difficult to both use a flashlight and carry an object that requires two hands to lift. One alternative is a headlamp, which is a small flashlight mounted on an adjustable headband. However, standard headlamps sit just above the user's eyes, impairing his or her vision, and more upscale headlamps can be substantially expensive.

Various attempts have been made to solve problems found in illumination device art. Among these are found in: U.S. Pub. No. 2014/0293587 to Mark Anthony Suarkeo; U.S. Pat. No. 6,170,959 to Charles W. Richardson, III; U.S. Pat. No. 6,644,826 to Alvin S. Blum; U.S. Pat. No. 8,550,648 to Kurtice Smith; and U.S. Pat. No. 4,812,953 to Ask et al. This prior art is representative of user attachable illumination devices.

None of the above inventions and patents, taken either singly or in combination, is seen to describe the invention as claimed. Thus, a need exists for a reliable Wearable LED Lights, Wearable LED Lights comprises a specially designed lightweight wearable LED lights that wrap around a wearer's legs so they can see where they're going when they're out at night and to avoid the above-mentioned problems.

### BRIEF SUMMARY OF THE INVENTION

In view of the foregoing disadvantages inherent in the known illumination device art, the present invention provides a novel wearable LED path illuminator, offering consumers a practical solution to the aforementioned challenges. The general purpose of the present invention, which will be described subsequently in greater detail, is to provide a wearable LED path illuminator. The wearable LED path illuminator is a specially designed lightweight wearable LED lights that wrap around a wearer's legs so they can see where they're going when they're out at night. The wearable LED path illuminator as claimed does a better job of actually illuminating the ground in front of a user, as compared to a flashlight, so they can walk without worry.

Wearable LED Lights are lightweight and comfortable, providing a bright circle of light around the wearer without interfering with their line of sight. Get a leg up on low-light activities, and enjoy running, walking, hiking, biking, and more with wearable LED path illuminators while keeping your hands and line of sight free of obstruction. The wearable LED lights as claimed include a number of features, such as:
Lightweight, rechargeable, hands-free, waterproof, and durable
Ultra-comfortable
Adjustable strap and buckle ensure a perfect fit
LED strip lights and a reflective surface create an extra bright light
High, low, and off settings, plus a USB charging port
Perfect for running, walking, hiking, biking, camping, hunting, and fishing
Provides 180° of light, up to eye level and at a comfortable distance

The present invention holds significant improvements and serves as a wearable LED path illuminator. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a wearable LED path illuminator, constructed and operative according to the teachings of the present invention.

FIG. 1 shows a perspective view illustrating a wearable LED path illuminator, according to an embodiment of the presently claimed invention.

FIG. 2 is a perspective view illustrating a wearable LED path illuminator, according to an embodiment of the presently claimed invention of FIG. 1.

FIG. 3 is a perspective view illustrating the buckle and control switch of a wearable LED path illuminator, according to an embodiment of the presently claimed invention of FIG. 1.

FIG. 4 is a perspective view illustrating a user wearing a pair of wearable LED path illuminators, according to an embodiment of the presently claimed invention of FIG. 1.

FIG. 5 is a closer perspective view illustrating a user wearing a pair of wearable LED path illuminators, according to an embodiment of the presently claimed invention of FIG. 1

The various embodiments of the present invention will hereinafter be described in conjunction with the appended drawings.

### DETAILED DESCRIPTION

As discussed above, the wearable LED path illuminator includes embodiments of the presently claimed invention that relate to an illumination device and more particularly to wearable LED path illuminators—downward facing LED ring-shaped flashlights for your legs.

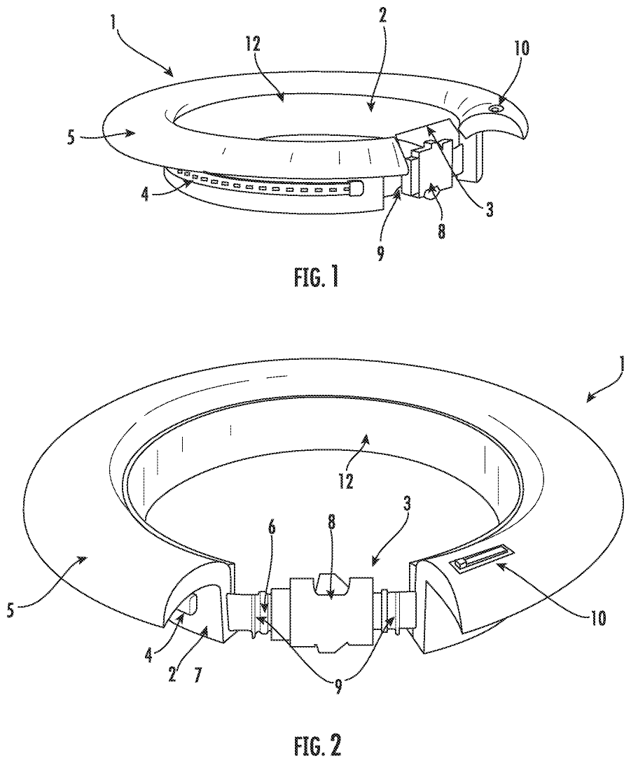

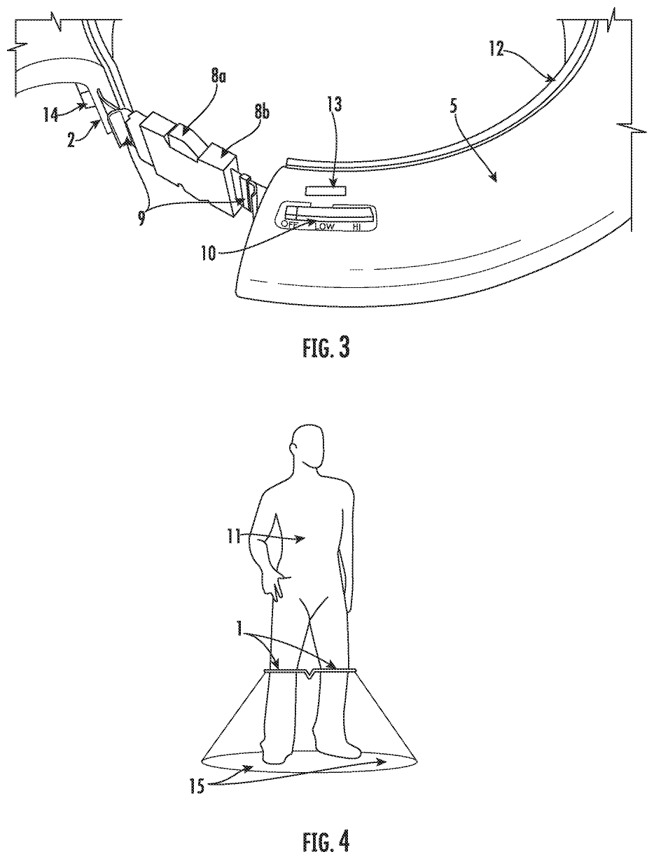

Referring now to the drawings FIGS. 1-2, the wearable LED path illuminator 1 includes a leg ring 2 with a gap 3 therein. The leg ring 2 has an inside that abuts the user's leg, and an outside, and may be u-shaped, as shown in FIG. 2. The inside side of the leg ring 2 may be lined with a comfort layer 12 formed of a soft and conforming material such as foam or rubber, in order to provide more comfort against the user's leg. A strip of light emitting diode (LED) lights 4 is position on the outside of the leg ring 2. The inside of the leg ring 2 is preferably padded for the user's comfort. A concave reflection ring 5 is located along a top edge of the leg ring 2. The reflection ring 5 has a reflecting coating on the inner surface, to reflect the light emitted by the LED lights 4 downwards, thereby creating a brighter light for the user 11 to see by.

As shown in FIG. 2, the reflection ring 5 may have a connection piece 6 at essentially a ninety-degree angle along an inner edge. The connection piece 6 preferably slots into the center section of the u-shaped leg ring 2 so that the bottom connection portion 7 of the u-shape is at the bottom edge of the leg ring 2 and the open portion is at the top edge of the leg ring 2 and holds the connection piece 6 of the reflection ring 5.

As shown in FIGS. 1-2, a buckle 8 with an adjustable strap 9 at either end, enables the user to fasten the wearable LED path illuminator 1 around his or her leg and adjust the fit. The buckle 8 can be a standard buckle that fastens to parts together. The wearable LED path illuminator also has a control switch 10, preferably located on an upper surface of the reflection ring 5 so that the user 11 does not have to reach around or under any part of the wearable LED path illuminator 1 to access the control switch 10.

As shown in FIG. 3, the gap 3 in the leg ring 2 is bridged by the buckle 8. The buckle has a left side 8a and a right side 8b that slot together, and each side 8a, 8b is attached to an adjustable strap 9. The control switch 10 has an on/off switch, and preferably has switch for off, low, and high light levels. The LED light strip 4 is powered by a battery 14. The battery 14 is preferably rechargeable, and more preferably charged via a universal serial bus (USB) charging port 13.

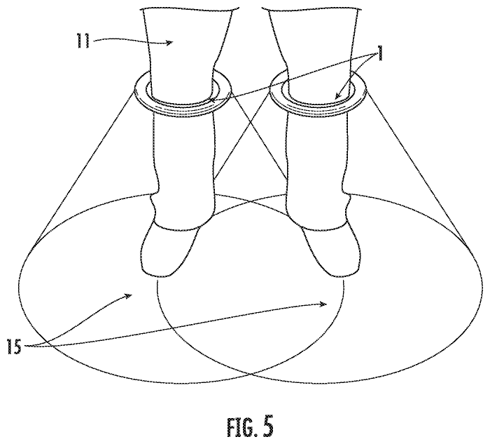

As shown in FIGS. 4-5, a user 11 attaches a wearable LED path illuminator 1 to one or more legs. The wearable LED path illuminator 1 casts a ring of light 15 around the user's 11 leg, thereby illuminating the path at the user's feet. The ring of light 15 provides a ring of at least 180° of light that is visible from eye level and illuminates a comfortable amount of the path at the user's feet.

The Wearable LED path illuminator is cost-effective to produce in the embodiments, as shown in FIGS. 1-5.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A wearable LED path illuminator comprising:
a. a leg ring with a gap therein;
b. a strip of LED lights, wherein the strip of LED lights is operably positioned along an outer surface of the leg ring;
c. a battery, wherein the battery is operably connected to the strip of LED lights in order to power the strip of LED lights;
d. a buckle with a left side and a right side, where in the left side and the right side of the buckle are connectable to each other;
e. a first adjustable strap, wherein the first adjustable straps is operably connected at a first end to the left side of the buckle and at a second end to a left side of the gap in the leg ring;
f. a second adjustable strap, wherein the second adjustable straps is operably connected at a first end to the right side of the buckle and at a second end to a right side of the gap in the leg ring;
g. a concave light reflector operably connected to a top edge of the leg ring so that it reflects light emitted by the strip of LED lights in a downward direction by the concave curve, wherein the underside of the concave light reflector is formed of a reflective material; and
h. a control switch, wherein the control switch is operably connected to the strip of LED lights, or the battery, or the strip of LED lights and the battery, to control turning the strip of LED lights on and off.

2. The wearable LED path illuminator according to claim 1, wherein the control switch has an off setting, a low light setting, and a high light setting.

3. The wearable LED path illuminator according to claim 1, wherein the leg ring has a u-shape.

4. The wearable LED path illuminator according to claim 3,
wherein the concave reflection ring has a connection piece operably connected at essentially a ninety-degree angle along an inner edge, and
wherein the connection piece operably slots into the opening in the u-shaped leg ring.

5. The wearable LED path illuminator according to claim 1, wherein the control switch is operably located on an upper surface of the concave reflection ring so that the user does not have to reach around or under the concave reflection ring to control the strip of LED lights.

6. The wearable LED path illuminator according to claim 1, wherein an inner surface of the leg ring is lined with a soft, padded material to protect the user's leg.

7. The wearable LED path illuminator according to claim 6, wherein the soft, padded material is selected from the group consisting of foam and rubber.

8. The wearable LED path illuminator according to claim 1, wherein the battery is a rechargeable battery.

9. The wearable LED path illuminator according to claim 8, further comprising:
i. a USB charging port operably connected to the battery to charge the battery.

10. The wearable LED path illuminator according to claim 1, wherein the wearable LED path illuminator casts an arc of light in a downward direction towards the user's feet, and wherein the arc of light or the ring of light is at least 180°.

11. A wearable LED path illuminator comprising:
a. a leg ring with a gap therein,
wherein the leg ring has a u-shape with an inner surface, an outer surface, a connecting base surface, and an opening at a top edge;
b. a strip of LED lights, wherein the strip of LED lights is operably positioned along the outer surface of the leg ring;
c. a rechargeable battery, wherein the battery is operably connected to the strip of LED lights in order to power the strip of LED lights;
d. a buckle with a left side and a right side, where in the left side and the right side of the buckle are connectable to each other;
e. a first adjustable strap, wherein the first adjustable straps is operably connected at a first end to the left side of the buckle and at a second end to a left side of the gap in the leg ring;
f. a second adjustable strap, wherein the second adjustable straps is operably connected at a first end to the right side of the buckle and at a second end to a right side of the gap in the leg ring;
g. a concave light reflector,
wherein the concave light reflector is operably connected to a top edge of the leg ring so that it reflects light emitted by the strip of LED lights in a downward direction by the concave curve,
wherein the underside of the concave light reflector is formed of a reflective material,
wherein the concave reflection ring has a connection piece operably connected at essentially a ninety-degree angle along an inner edge, and
wherein the connection piece operably slots into the opening in the u-shaped leg ring;
h. a control switch,
wherein the control switch is operably connected to the strip of LED lights, or the battery, or the strip of LED lights and the battery, to control turning the strip of LED lights on and off,
wherein the control switch has an off setting, a low light setting, and a high light setting, and
wherein the control switch is operably located on an upper surface of the concave reflection ring so that the user does not have to reach around or under the concave reflection ring to control the strip of LED lights;
i. a soft lining, wherein the soft lining is operably attached to the inner surface of the leg ring; and
j. a USB charging port operably connected to the battery to charge the battery.

12. The wearable LED path illuminator according to claim 11, wherein the soft, padded material is selected from the group consisting of foam and rubber.

13. The wearable LED path illuminator according to claim 11, wherein the wearable LED path illuminator casts an arc of light in a downward direction towards the user's feet, and
wherein the arc of light or the ring of light is at least 180°.
